(19) United States
(12) Patent Application Publication
(10) Pub. No.: US 2014/0041264 A1
(43) Pub. Date: Feb. 13, 2014

(54) Greeting card incorporating electronics device pocket

(71) Applicant: Donald Chambers, Urbana, IL (US)

(72) Inventor: Donald Chambers, Urbana, IL (US)

(21) Appl. No.: 13/507,920

(22) Filed: Aug. 7, 2012

(51) Int. Cl. G09F 1/00

(52) U.S. Cl. 40/124.06

(57) ABSTRACT

Greeting card with an electronic screen incorporated in any way into or onto the material, are described herein having a durable body composed of heavy gauge vinyl, leather, rubber, wood, foam, cloth, or any material capable of withstanding frequent use. The incorporated screen in the durable body may be located in the front, back, or inside of the card, depending upon the size and style of the electronic device and/or the style or type of greeting message. The greeting card may include panels, holes, or open areas which may be located throughout various locations on the durable greeting card body to provide access to any number of ports, buttons, screens, keypads, switches, or a combination thereof.

### CROSS-REFERENCE TO RELATED APPLICATIONS

This application relates to the design patent titled GREETING CARD WITH POCKET FOR AN ELECTRONIC DEVICE by Donald Chambers, U.S. PTO # D685,418, date of patent Jul. 2, 2013.

### BACKGROUND

Traditional greeting cards have been used for years, most frequently sent through the mail or presented in person to express congratulations, love, or celebration of a specific event or milestone. Greetings made of paper are often treasured for their sentimental value, yet serve no additional purpose. These paper cards are most frequently placed into storage, or simply discarded soon after delivery. More recently, many consumers are now seeking products with additional value or purpose beyond traditional use. As the world population increasingly relies upon some form of electronic device for their daily activities, a greeting which is able to become, hold, or protect their electronic communications device as well as remind them of a special person or event in their life is likely to become increasingly popular and useful.

### SUMMARY

A three-dimensional durable greeting card is described herein, the words for the first part of the greeting message on the outside front cover, the words for the second part of the greeting message on the inside left or right portion of the card. Any portion of the card itself may be of a generic size, or designed to fit a specific brand or model of electronic device or telephone to provide access to any number of ports, buttons, screens, keypads, switches, or a combination thereof.

The electronic device and/or display screen itself is in any way incorporated into or onto the material composing the card.

Unless otherwise defined, all technical terms used herein have the same meaning as commonly understood by one of ordinary skill in the art to which this invention belongs. In case of conflict, the present specification, including definitions, will control.

Any feature or combination of features described herein are included within the scope of the present invention provided that the features included in any such combination are not mutually inconsistent as will be apparent from the context, this specification and the knowledge of one of ordinary skill in the art. In addition, the materials, methods, and examples are illustrative only and not intended to be limiting. Thus, specific details described herein such as, for example, the style and size attachment area for the electronic device are provided for purposes of explanation and not intended to be limiting. Although methods and materials similar or equivalent to those described herein can be used to practice the invention, suitable methods and materials are described below.

Other features and advantages of the invention will be apparent from the following detailed description and from the claims.

### BRIEF DESCRIPTION OF THE DRAWINGS

FIG. 1 is a front and bottom perspective view, with the card slightly open, of an embodiment of the greeting card of the present invention.

FIG. 2 is front and top perspective view of the greeting card, with the card closed.

FIG. 3 is a back and top perspective view of the greeting card, with the card closed.

FIG. 4 is an inside and top perspective view with a sample electronic device built into or onto an embodiment of the greeting card of the present invention.

FIG. 5 is a top perspective view of the greeting card, with the card open

### DETAILED DESCRIPTION OF PREFERRED EMBODIMENTS

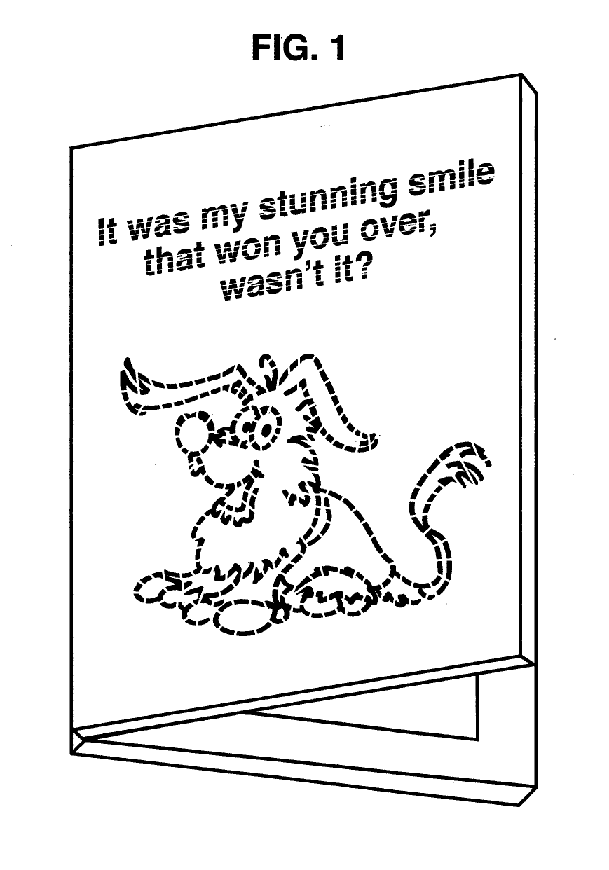

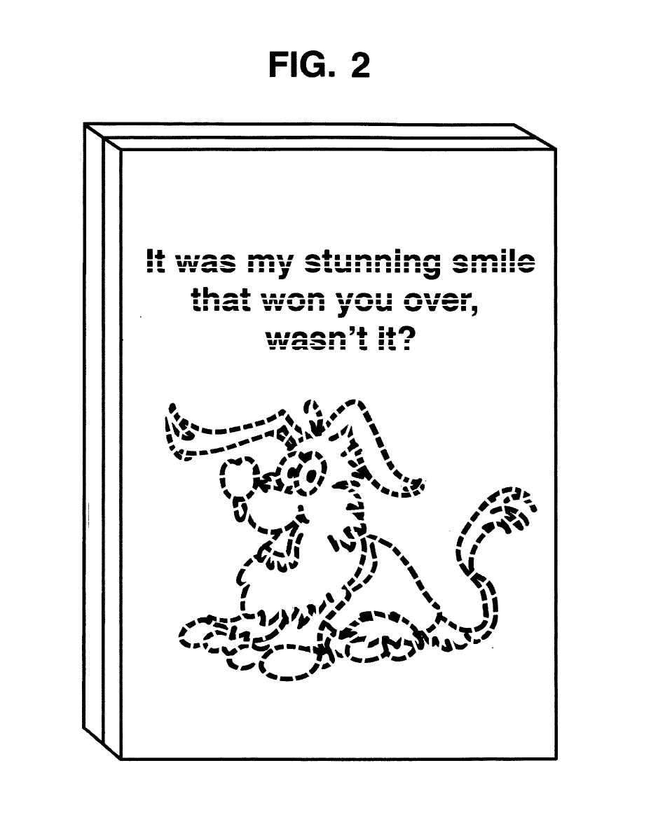

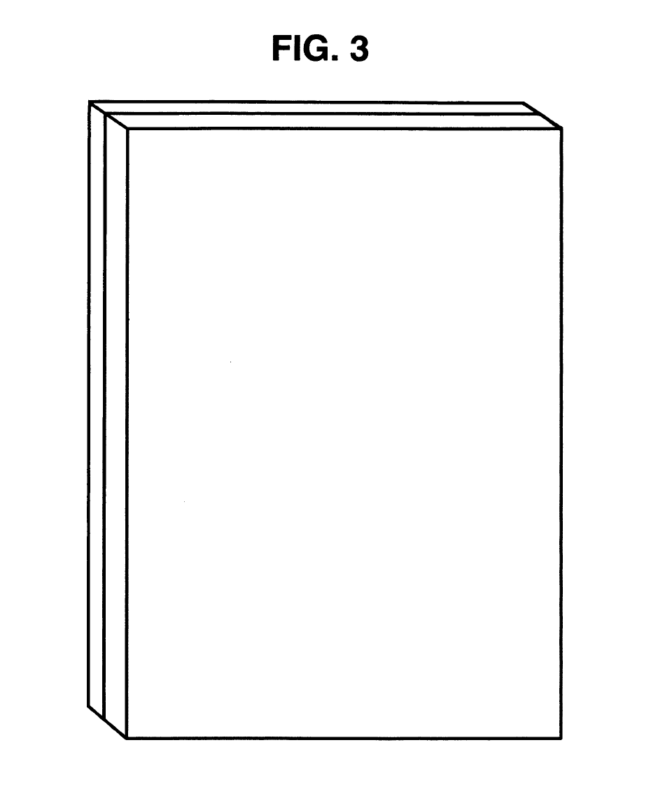

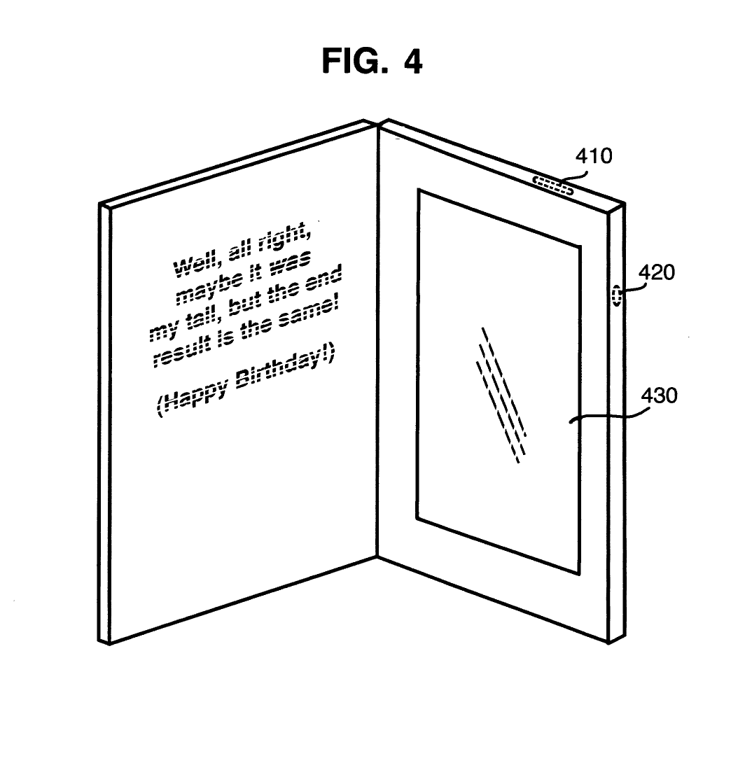

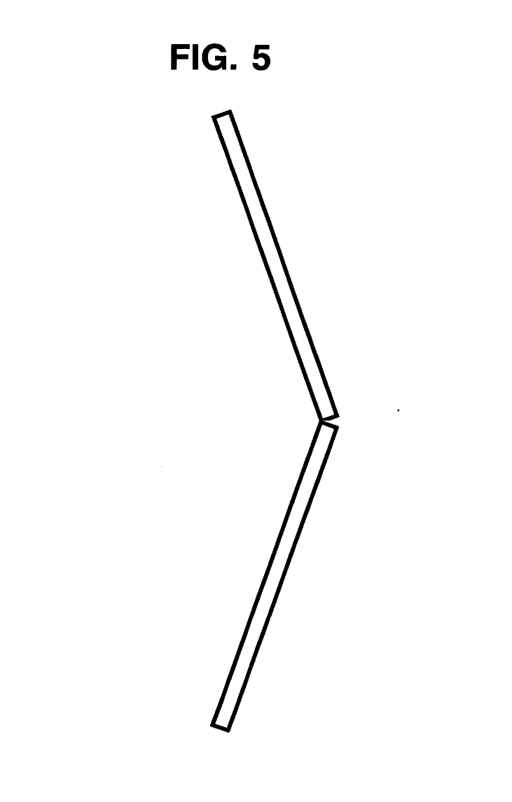

In one form, a greeting card according to the present invention features a durable body of leather, vinyl, rubber, plastic, wood, foam, or any material capable of withstanding frequent use. The durable body of the greeting card may be formed into a square or rectangular shape of a traditional greeting card, as shown in FIGS. 1-5. Or the greeting card can be formed into any shape or profile, examples of which include, but are not limited to: a heart, a circle, an animal, a Christmas tree, a pumpkin, a wrench, a purse, or any other conceivable shape. The front and back surfaces of the durable body are generally planar and can be composed of or covered with any material capable of withstanding frequent use. The greeting card may feature a single fold as featured in FIGS. 1-5, or any number of multiple folds in any direction. Any surface of the greeting card may remain plain, or feature words or images consistent with the greeting message, the shape of the card, or the item or items contained within the card. The written and pictorial matter in FIGS. 1-5 are not part of the design sought to be patented, and being merely exemplary of any lettering and pictures which could be applied to the greeting card. Any portion of the card may feature access holes or ports as 410 and 420 in FIG. 4 in any style, quantity or configuration to allow for control of any electronic device. 410 and 420 in FIG. 4 are merely exemplary of any holes or ports which could be incorporated into the card. The electronic device and/or display screen itself 430 in FIG. 4 may in any way be incorporated into or onto the material composing the card.

While various aspects and embodiments have been disclosed herein, other aspects and embodiments will be apparent to those skilled in the art. The various aspects and embodiments disclosed herein are for purposed of illustration only and are not intended to be limiting, with the true scope and spirit being indicated by the following claims.

### FIELD OF THE INVENTION

The present invention relates to greeting cards, and more specifically to durable greeting cards incorporating an electronic screen.

What is claimed is:

1. A durable greeting card comprising: A reflective message inside and/or outside of the card, or solely or in combination with any message which may appear on an electronic device screen contained within, attached to the inside or the outside of the card, or in any way incorporated into or onto the material of the card; A three-dimensional body composed vinyl, leather, rubber, wood, foam, cloth, or any material capable of withstanding frequent use; a partially hollowed cavity section, or one or more pockets within the durable body capable of securely holding and/or protecting the electronic device or telephone contained within the greeting card; The pocket(s) or cavity in the durable body may be located in the front, back, or inside of the card on either side, depending upon the size and style of the electronic device and/or the style or type of greeting message. The greeting card may include any number of panels, holes, or open areas which may be located throughout various locations on the durable greeting card body to provide access to any number of ports, buttons, screens, keypads, switches, or a combination thereof.

2. A durable greeting card of claim 1, wherein the partially hollowed cavity section, or one or more pockets within or outside the durable body, may be of a generic size to fit a wide variety of electronic devices or telephones, or designed to the specific dimensions of a particular make and/or model of electronic device or telephone.

3. A durable greeting card of claim 1, wherein any number of access panels, holes, or open areas for ports, buttons, screens, keypads, switches, or a combination thereof may also be of a generic size, style, or pattern to fit a wide variety of electronic devices or telephones, or designed to the specific dimensions of a particular make and/or model of electronic device or telephone.

4. A durable greeting card of claim 1, wherein the display screen, or any portion of the display screen, of the electronic device or telephone is visible through an opening in the outside front or back panel of the three-dimensional greeting card body, and may or may not feature an image printed on a protective cover over the display screen, or enable the viewing of an actual electronic message on an electronic device or telephone, or any sample or mock up device which may be inserted within the pocket or cavity prior to the sale for display, sample, or demonstration purposes.

5. A durable greeting card of claim 1, wherein the card may be designed with any number or style of folds, flaps, bends, windows, sliding areas, or panels inside or outside of the card which ultimately allow access to the display screen of the electronic device or telephone contained within the pocket, or built-in electronic device.

6. A durable greeting card of claim 1, wherein the electronic device and display screen itself is in any way incorporated into or onto the material composing the card inside, outside, or in any fold, flap, bend, window or sliding area of the card.
